(19) United States
(12) Patent Application Publication
(10) Pub. No.: US 2016/0332470 A1
(43) Pub. Date: Nov. 17, 2016

(54) DYE RIBBON FOR SUBLIMATION THERMAL TRANSFER PRINTING

(71) Applicant: Chien Hwa Coating Technology, Inc., Hsinchu (TW)

(72) Inventors: Tze-Wei LIU, Hsinchu (TW); Chien-Sen HUANG, Hsinchu (TW)

(21) Appl. No.: 14/803,130

(22) Filed: Jul. 20, 2015

(30) Foreign Application Priority Data
May 15, 2015 (TW) 104115627

(51) Int. Cl. B41M 5/42; B41M 5/41

(52) U.S. Cl. CPC B41M 5/426; B41M 5/41

(57) ABSTRACT

The present disclosure provides a dye ribbon for sublimation thermal transfer printing including a ribbon body and a dye layer. The ribbon body includes a substrate and a lubricating and thermal resistant material. The lubricating and thermal resistant material is dispersed in the substrate, and the content of which is 0.5-20% of weight of the substrate. The dye layer is disposed on the ribbon body.

### BACKGROUND

This application claims priority to Taiwan Application Serial Number 104115627, filed May 15, 2015, which is incorporated herein by reference.

### FIELD OF INVENTION

The present disclosure relates to a dye ribbon. More particularly, the present disclosure relates to a dye ribbon for sublimation thermal transfer printing.

### DESCRIPTION OF RELATED ART

In accordance with a requirement of high color density for a dye ribbon for sublimation thermal transfer printing, a heater of a sublimation thermal transfer printing device needs to provide high temperature to the dye ribbon. Recently, a conventional dye ribbon for sublimation thermal transfer printing is usually composed of a polyethylene terephthalate (PET) film as a ribbon body. Further, a dye layer is formed on a surface of the PET film, and a back-side layer is formed on another surface of the PET film. Therefore, the conventional dye ribbon may solve issues such as a color ribbon broken by the high temperature of the heater, printing defect occurred by polymers attached on the heater, or unsmooth printing.

In detail, a thermal resistant layer, also called the back-side layer, may be coated on a surface of the ribbon body of a dye ribbon for sublimation thermal transfer printing, so as to prevent the mentioned issues. A formation of the thermal resistant layer can be directly coating a silicone oil on a surface of the ribbon body by spray coating or drop coating, or can be coating a thermal resistant ink on a surface of the ribbon body. The thermal resistant ink is composed of organic and inorganic lubricant, metal or inorganic particle, and polymer material. In addition, considering a stability of the color ribbon for long-term storage, the second formation of the back-side layer is the main method in sublimation thermal transfer printing applications. From this, the back-side layer, which is composed of liquid or solid lubricant, and metal or inorganic powder, can prevent such issues occurred by the high temperature of the heater, such as the color ribbon broken and the unsmooth printing.

However, a material of the back-side layer is generally a reactive material, so that the reactive material has a limitation of an expiration date. If the thermal resist material of the back-side layer cannot be completely used in the expiration date, it is needed to be scrapped, so as to increase a production and storage cost of the conventional dye ribbon. In addition, a lubricating agent and an inorganic powder may be added into the back-side layer in the conventional dye ribbon. When the thermal resist material containing these adducts is coated on the second surface of the ribbon body by a scraper, the thermal resist material is easy to accumulate on the scraper, so that a thread defect is occurred on the coated back-side layer. Accordingly, there is a need for an improved coated structure for antifouling or fouling-resistant treatment to solve the aforementioned problems met in the art.

### SUMMARY

In view of the problem in the art, the present disclosure provides a novel dye ribbon for sublimation thermal transfer printing, in which a lubricating and thermal resistant material is dispersed in a substrate of a ribbon body, so that there is no need to form an additional back-side layer on a surface of the ribbon body opposite to the dye layer to give a lubricating and thermal resistant property, and there is no problem about an expiration date and unevenly coating of a coating material of a back-side layer in a conventional ribbon. On another aspect, a whole thickness of the dye ribbon provided by the present disclosure may be reduced due to the absence of the additional back-side layer on the ribbon body.

An embodiment of the present disclosure is provided a dye ribbon for sublimation thermal transfer printing. The dye ribbon includes a ribbon body and a dye layer. The ribbon body includes a substrate and a lubricating and thermal resistant material. The lubricating and thermal resistant material is dispersed in the substrate, and a content of the lubricating and thermal resistant material is in a range of 0.5-20% of weight of the substrate. The dye layer is disposed on the ribbon body.

According to various embodiments of the present disclosure, the substrate is a flexible substrate.

According to various embodiments of the present disclosure, a material of the flexible substrate is selected from the group consisting of polyethylene terephthalate (PET), polypropylene (PP), polyamide (PA), polyimide (PI), polystyrene (PS), polycarbonate (PC) and polyurethane (PU).

According to various embodiments of the present disclosure, the lubricating and thermal resistant material is selected from the group consisting of talc, SiO2, CaCO3, aluminum nitride (AlN), SiC, Si3N4, boron nitride (BN), Al2O3, TiO2, CuO, carbon black, graphite, graphene, carbon nanotube and a combination thereof.

According to various embodiments of the present disclosure, a particle size of the lubricating and thermal resistant material is in a range of 10 nm to 3 μm.

According to various embodiments of the present disclosure, the dye layer comprises one or more color blocks.

According to various embodiments of the present disclosure, the dye layer further comprises a protection block.

According to various embodiments of the present disclosure, the dye layer is directly in contact with a surface of the ribbon body.

According to various embodiments of the present disclosure, the dye ribbon further includes an adhesive layer disposed between the ribbon body and the dye layer.

According to various embodiments of the present disclosure, a thickness of the ribbon body is in a range of 3-5.5 μm.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic cross-sectional view of a conventional dye ribbon for sublimation thermal transfer printing; and

FIGS. 2 and 3 are schematic cross-sectional views of dye ribbons for sublimation thermal transfer printing in accordance with various embodiments of the present disclosure.

### DETAILED DESCRIPTION

The singular forms “a,” “an” and “the” used herein include plural referents unless the context clearly dictates otherwise. Therefore, reference to, for example, a metal layer includes embodiments having two or more such metal layers, unless the context clearly indicates otherwise. Reference throughout this specification to “one embodiment” means that a particular feature, structure, or characteristic described in connection with the embodiment is included in at least one embodiment of the present disclosure. Therefore, the appearances of the phrases “in one embodiment” or “in an embodiment” in various places throughout this specification are not necessarily all referring to the same embodiment. Further, the particular features, structures, or characteristics may be combined in any suitable manner in one or more embodiments. It should be appreciated that the following figures are not drawn to scale; rather, the figures are intended; rather, these figures are intended for illustration.

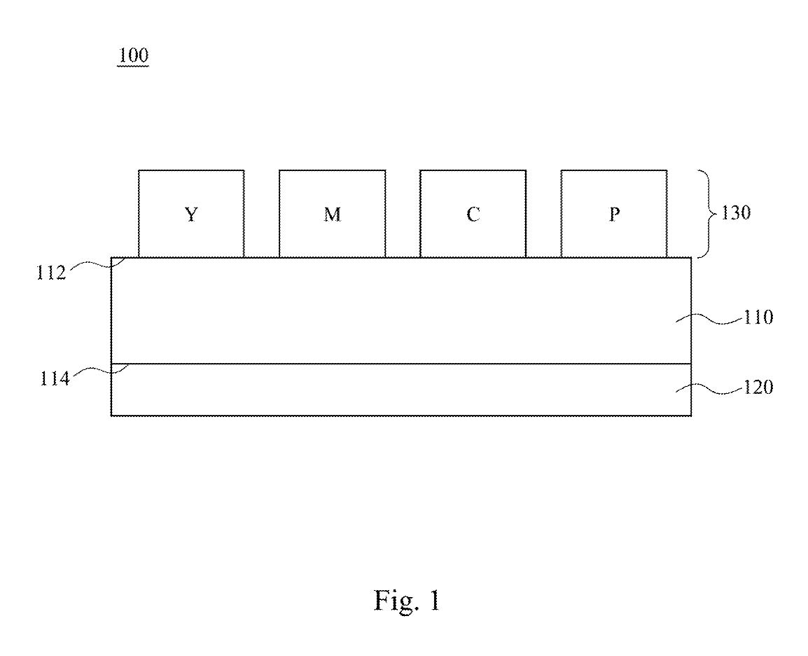

FIG. 1 is a schematic cross-sectional view of a conventional dye ribbon 100 for sublimation thermal transfer printing. In FIG. 1, dye ribbon 100 is composed of a ribbon body 110, a back-side layer 120 and a dye layer 130.

The ribbon body 110 has a first surface 112 and a second surface 114 opposite to the first surface 112. The dye layer 120 is disposed on the first surface 112 of the ribbon body 110; and the back-side layer 130 is disposed on the second surface 114 of the ribbon body 110.

The ribbon body 110 is formed of polyethylene terephthalate (PET), and the thickness of which is about 4.5 μm. The back-side layer 120 is formed of a mixture of a cellulose acetate propionate resin, a polyisocyanate harder and a fatty acid metal salt. The dye layer 130 is formed of a mixture of a polyvinyl butyeal resin and a single-color dye.

In a structure of the ribbon 100, the back-side layer 120 usually transfers heat to the ribbon body 110 by a thermal resistant material to heat the dye layer 130 on the first surface 112 of the ribbon body 110, such that the dye layer 130 may be heated and sublimated to transfer onto a surface of an object to be printed (not shown). However, the thermal resist material of the back-side layer 120 has a limitation of an expiration date. If the thermal resist material of the back-side layer 120 cannot be completely used in the expiration date, it is needed to be scrapped, so as to increase a production and storage cost of the conventional dye ribbon 100 for thermal sublimation transfer printing.

In another aspect, a lubricating agent and an inorganic powder may be added into the back-side layer 120 in the conventional dye ribbon 100. When the thermal resist material containing these adducts is coated on the second surface 114 of the ribbon body 110 by a scraper, the thermal resist material is easy to accumulate on the scraper, so that a thread defect is occurred on the coated back-side layer 120.

In addition, a whole thickness of the ribbon body 110, the back-side layer 120 and the dye layer 130 may not be reduced due to the limitation of the conventional process, so that applications of the conventional dye ribbon 100 are limited.

In view of the problem in the art, the present disclosure provides a novel dye ribbon for sublimation thermal transfer printing, in which a lubricating and thermal resistant material is dispersed in a substrate of a ribbon body, so that there is no need to form an additional back-side layer on a surface of the ribbon body opposite to the dye layer to give a lubricating and thermal resistant property, and there is no problem about an expiration date and unevenly coating of a coating material of a back-side layer in a conventional ribbon. On another aspect, a whole thickness of the dye ribbon provided by the present disclosure may be reduced due to the absence of the additional back-side layer on the ribbon body.

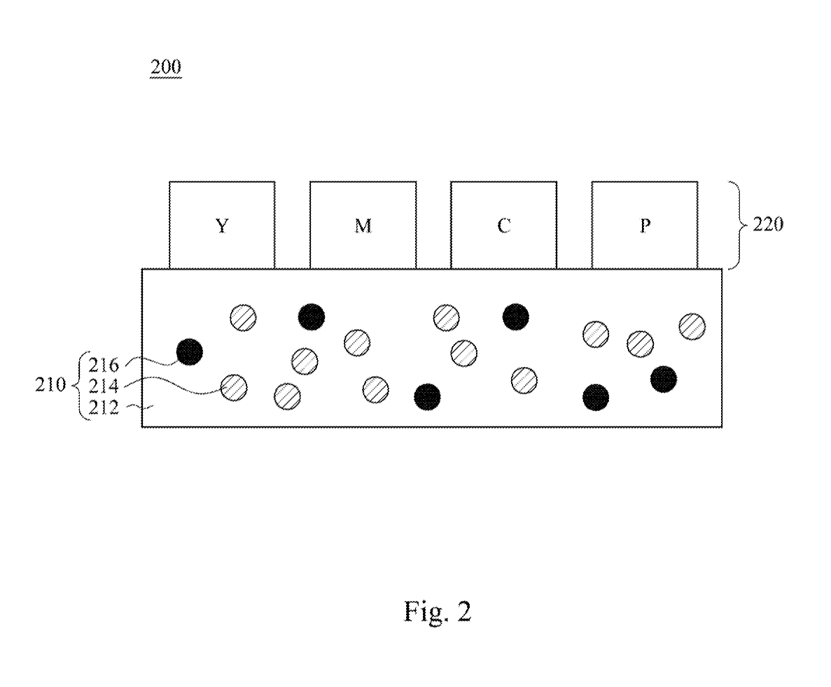

FIG. 2 is a schematic cross-sectional view of a dye ribbon 200 for sublimation thermal transfer printing in accordance with various embodiments of the present disclosure. In FIG. 2, the dye ribbon 200 is composed of a ribbon body 210 and a dye layer 220.

The ribbon body 210 includes a substrate 212 and lubricating and thermal resistant materials 214 and 216. According to various embodiments of the present disclosure, a thickness of the ribbon body 210 is 3-5.5 μm. According to various embodiments of the present disclosure, the substrate 212 is a flexible substrate, and a material of which is selected from the group consisting of polyethylene terephthalate (PET), polypropylene (PP), polyamide (PA), polyimide (PI), polystyrene (PS), polycarbonate (PC) and polyurethane (PU).

The lubricating and thermal resistant materials 214 and 216 are dispersed in the substrate 212. According to various embodiments of the present disclosure, the lubricating and thermal resistant materials 214 and 216 are individually selected from the group consisting of talc, SiO2, CaCO3, aluminum nitride (AlN), SiC, Si3N4, boron nitride (BN), Al2O3, TiO2, CuO, carbon black, graphite, graphene, carbon nanotube and a combination thereof. According to various embodiments of the present disclosure, particle sizes of the lubricating and thermal resistant materials 214 and 216 are individually in a range of 10 nm to 3 μm.

According to various embodiments of the present disclosure, the lubricating and thermal resistant materials 214 and 216 are the same material. According to various embodiments of the present disclosure, both of the lubricating and thermal resistant materials 214 and 216 are talc, SiO2 or carbon black.

According to various embodiments of the present disclosure, the lubricating and thermal resistant materials 214 and 216 are different materials According to various embodiments of the present disclosure, the lubricating and thermal resistant materials 214 and 216 are a combination of SiO2 and carbon black, a combination of SiO2 and talc, or a combination of talc and carbon black.

The dye layer 220 is disposed on the ribbon body 210. According to various embodiments of the present disclosure, the dye layer 220 includes one or more color blocks. According to various embodiments of the present disclosure, the color blocks are individually in magenta, yellow, blue or a combination thereof. According to various embodiments of the present disclosure, the dye layer 220 directly contacts a surface of the ribbon body 210. According to various embodiments of the present disclosure, the dye layer 220 further includes a protection block which is formed of a resin.

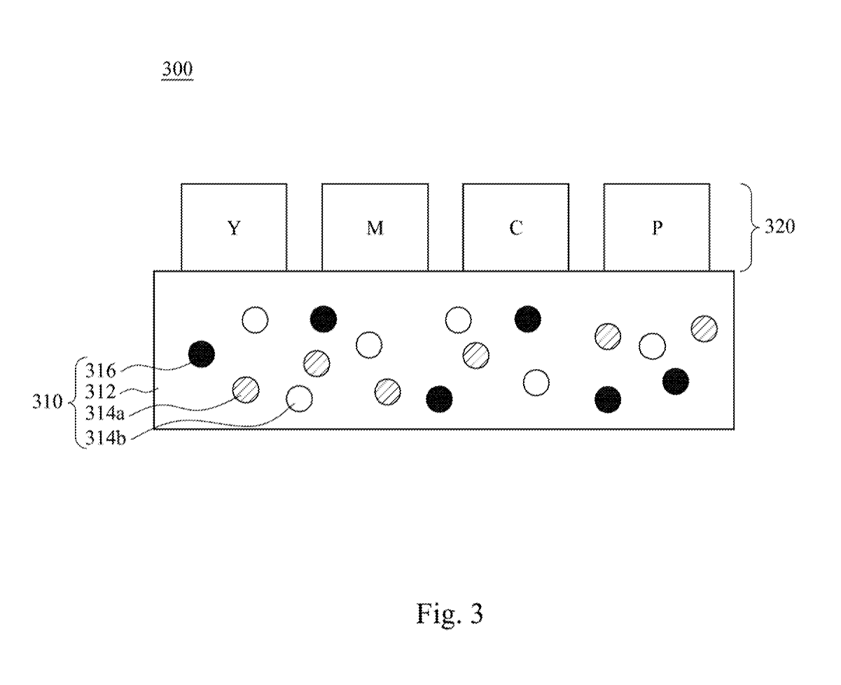

FIG. 3 is a schematic cross-sectional view of a dye ribbon 300 for sublimation thermal transfer printing in accordance with various embodiments of the present disclosure. In FIG. 3, the dye ribbon 300 is composed of a ribbon body 310 and a dye layer 320.

Different from the dye ribbon 200 in FIG. 2, the ribbon body of the dye ribbon 300 in FIG. 3 includes a substrate 312 and lubricating and thermal resistant materials 314a, 314b and 316. The lubricating and thermal resistant materials 314a, 314b and 316 are dispersed in the substrate 312. According to various embodiments of the present disclosure, contents of the lubricating and thermal resistant materials 314a, 314b and 316 are 0.5-20% of the weight of the substrate 312. According to various embodiments of the present disclosure, the lubricating and thermal resistant materials 314a, 314b and 316 are different materials. According to various embodiments of the present disclosure, the lubricating and thermal resistant materials 314a, 314b and 316 are talc, SiO2 and carbon black, respectively.

The dye layer 320 is disposed on the ribbon body 310. According to various embodiments of the present disclosure, the dye layer 320 includes one or more color blocks. According to various embodiments of the present disclosure, the color blocks are individually in magenta, yellow, blue or a combination thereof. According to various embodiments of the present disclosure, the dye layer 320 directly contacts a surface of the ribbon body 310. According to various embodiments of the present disclosure, the dye layer 320 further includes a protection block which is formed of a resin.

Next, a method for manufacturing a dye ribbon for sublimation thermal transfer printing in accordance with various embodiments of the present disclosure is exemplarily illustrated as following.

### Embodiment 1

1.1 Silicon oxide (SiO₂) and polyethylene terephthalate (PET) are mixed together, wherein the mass ratio of SiO₂ and PET are 1:4. The SiO₂ is selected from one modified by dimethyldichlorosilane which is also named AEROSIL R 972, and a mean particle size of which is around 16 nm. In addition, the PET particles and the SiO₂ are mixed by mechanical agitation, such that the SiO₂ is adsorbed in a surface of the PET particles.
1.2 The mixed components are sequentially melted, cooled at 20° C. and cut by a twin-screw granulation machine, so that a SiO₂/PET masterbatch is provided. In addition, the temperature of the twin-screw granulation machine is in a range of 250-270° C.
1.3 The SiO₂/PET masterbatch in step 1.2 is mixed with purified PET particles by mechanical agitation, so as to decrease the content of SiO₂ to 0.3 wt %. Further, they are dried at 150° C. for 4 hrs. The dried particles are extruded by a single-screw extruder to form a flat film, wherein a condition of the single-screw extruder is described as following. A temperature of a screw of the extruder is in a range of 250-270° C. A temperature of an extrusion die of the extruder is in a range of 250-280° C. A temperature of a cooling roll of the extruder is in a range of 30° C. A rotational speed of the screw is in a range of 30-40 rpm. A rotational speed of a meter of the extruder is in a range of 10-15 rpm. A take-up speed of the extruder is in a range of 3-4 m/min. As a result, a thickness of the flat film is around 40 μm.
1.4 The flat film provided in step 1.3 is biaxial oriented by a biaxial oriented machine. The oriented temperature is 105° C. The oriented magnification is 3×3. The temperature of heat setting is 210° C. As a result, a ribbon body in embodiment 1 is provided, and a thickness of which is around 4.5 μm.
1.5 Further, a forming process of a dye layer of the dye ribbon for sublimation thermal transfer printing is described as following. A ribbon body with 4.5-μm thickness is provided. An adhesion layer of 0.2 g/m² is coated on a surface of the ribbon body, and then a color layer of 1.2 g/m² is coated on the adhesion layer. In an embodiment of the present disclosure, a material of the adhesion layer is a polyvinylpyrrolidone (PVP)-series resin, such as PVP K-60 (ISP); and a composition of the color layer is 50 wt % of polyvinyl butyl resin (PVB) and 50 wt % of pigment, such as a mixed pigment composed of Cl Solvent Blue 63 (30 wt %) and Cl Solvent Blue 354 (20 wt %).

### Embodiment 2

2.1 SiO₂ (R972) and PET are mixed together, wherein the mass ratio of SiO₂ and PET are 1:4. The SiO₂ is selected from one modified by dimethyldichlorosilane which is also named AEROSIL R 972, and a mean particle size of which is around 16 nm. In addition, the PET particles and the SiO₂ are mixed by mechanical agitation, such that the SiO₂ is adsorbed in a surface of the PET particles.
2.2 The mixed components are sequentially melted, cooled at 20° C. and cut by a twin-screw granulation machine, so that a SiO₂/PET masterbatch is provided. In addition, the temperature of the twin-screw granulation machine is in a range of 250-270° C.
2.3 The SiO₂/PET masterbatch in step 2.2 is mixed with purified PET particles by mechanical agitation, so as to decrease the content of SiO₂ to 5 wt %. Further, they are dried at 150° C. for 4 hrs. The dried particles are extruded by a single crew extruder to form a flat film, wherein a condition of the single-screw extruder is described as following. A temperature of a screw of the extruder is in a range of 250-270° C. A temperature of an extrusion die of the extruder is in a range of 250-280° C. A temperature of a cooling roll of the extruder is in a range of 30° C. A rotational speed of the screw is in a range of 30-40 rpm. A rotational speed of a meter of the extruder is in a range of 10-15 rpm. A take-up speed of the extruder is in a range of 3-4 m/min. As a result, a thickness of the flat film is around 40 μm.
2.4 The flat film provided in step 2.3 is biaxial oriented by a biaxial oriented machine. The oriented temperature is 105° C. The oriented magnification is 3×3. The temperature of heat setting is 210° C. As a result, a ribbon body in embodiment 2 is provided, and a thickness of which is around 4.5 μm.
2.5 Further, a dye layer is formed on a surface of the ribbon body. The forming process of the dye layer in embodiment 2 is same as the step 1.5 described in embodiment 1.

### Embodiment 3

3.1 Carbon black (CB) and PET are mixed together, wherein the mass ratio of CB and PET are 1:4. The CB is available from CABOT, which is also named XC72, and a mean particle size of which is around 30 nm. In addition, a surface of the CB particle is chemically modified to have functional groups formed thereon, so as to increase the compatibility of CB and PET. The PET particles and the CB are mixed by mechanical agitation, such that the CB is adsorbed in a surface of the PET particles.
3.2 The mixed components are sequentially melted, cooled at 20° C. and cut by a twin-screw granulation machine, so that a CB/PET masterbatch is provided. In addition, the temperature of the twin-screw granulation machine is in a range of 250-270° C.
3.3 The CB/PET masterbatch in step 3.2 is mixed with purified PET particles by mechanical agitation, so as to decrease the content of CB to 5 wt %. Further, they are dried at 150° C. for 4 hrs. The dried particles are extruded by a single-screw extruder to form a flat film, wherein a condition of the single-screw extruder is described as following. A temperature of a screw of the extruder is in a range of 250-270° C. A temperature of an extrusion die of the extruder is in a range of 250-280° C. A temperature of a cooling roll of the extruder is in a range of 30° C. A rotational speed of the screw is in a range of 30-40 rpm. A rotational speed of a meter of the extruder is in a range of 10-15 rpm. A take-up speed of the extruder is in a range of 3-4 m/min. As a result, a thickness of the flat film is around 40 μm.
3.4 The flat film provided in step 3.3 is biaxial oriented by a biaxial oriented machine. The oriented temperature is 105° C. The oriented magnification is 3×3. The temperature of heat setting is 210° C. As a result, a ribbon body in embodiment 3 is provided, and a thickness of which is around 4.5 μm.
3.5 Further, a dye layer is formed on a surface of the ribbon body. The forming process of the dye layer in embodiment 3 is same as the step 1.5 described in embodiment 1.

### Embodiment 4

4.1 Talcum powder (Talc) and PET are mixed together, wherein the mass ratio of Talc and PET are 1:4. The Talc is available from MONDO, which is also named M03, and a mean particle size of which is around 30 nm. In addition, the Talc is mechanically polished to have a particle size being around 500 nm, and then a surface of the Talc is chemically modified to increase the compatibility of Talc and PET. The PET particles and the Talc are mixed by mechanical agitation, such that the Talc is adsorbed in a surface of the PET particles.
4.2 The mixed components are sequentially melted, cooled at 20° C. and cut by a twin-screw granulation machine, so that a Talc/PET masterbatch is provided. In addition, the temperature of the twin-screw granulation machine is in a range of 250-270° C.
4.3 The Talc/PET masterbatch in step 4.2 is mixed with purified PET particles by mechanical agitation, so as to decrease the content of Talc to 5 wt %. Further, they are dried at 150° C. for 4 hrs. The dried particles are extruded by a single-screw extruder to form a flat film, wherein a condition of the single-screw extruder is described as following. A temperature of a screw of the extruder is in a range of 250-270° C. A temperature of an extrusion die of the extruder is in a range of 250-280° C. A temperature of a cooling roll of the extruder is in a range of 30° C. A rotational speed of the screw is in a range of 30-40 rpm. A rotational speed of a meter of the extruder is in a range of 10-15 rpm. A take-up speed of the extruder is in a range of 3-4 m/min. As a result, a thickness of the flat film is around 40 μm.
4.4 The flat film provided in step 4.3 is biaxial oriented by a biaxial oriented machine. The oriented temperature is 105° C. The oriented magnification is 3×3. The temperature of heat setting is 210° C. As a result, a ribbon body in embodiment 4 is provided, and a thickness of which is around 4.5 μm.
4.5 Further, a dye layer is formed on a surface of the ribbon body. The forming process of the dye layer in embodiment 4 is me as the step 1.5 described in embodiment 1.

### Embodiment 5

5.1 The SiO₂/PET masterbatch provided from embodiment 2 and the CB/PET masterbatch provided from embodiment 3 are mixed together, wherein the mass ratio of both are 1:1. The mixed components are sequentially melted, cooled at 20° C. and cut by a twin-screw granulation machine, so that a SiO₂/CB/PET masterbatch is provided. In addition, the temperature of the twin-screw granulation machine is in a range of 250-270° C.
5.2 The SiO₂/CB/PET masterbatch is mixed with purified PET particles by mechanical agitation, so as to decrease the content of SiO₂ to 2.5 wt % and CB to 2.5%. Further, they are dried at 150° C. for 4 hrs. The dried particles are extruded by a single crew extruder to form a flat film, wherein a condition of the single-screw extruder is described as following. A temperature of a screw of the extruder is in a range of 250-270° C. A temperature of an extrusion die of the extruder is in a range of 250-280° C. A temperature of a cooling roll of the extruder is in a range of 30° C. A rotational speed of the screw is in a range of 30-40 rpm. A rotational speed of a meter of the extruder is in a range of 10-15 rpm. A take-up speed of the extruder is in a range of 3-4 m/min. As a result, a thickness of the flat film is around 40 μm.
5.3 The flat film provided in step 5.2 is biaxial oriented by a biaxial oriented machine. The oriented temperature is 105° C. The oriented magnification is 3×3. The temperature of heat setting is 210° C. As a result, a ribbon body in embodiment 5 is provided, and a thickness of which is around 4.5 μm.
5.4 Further, a dye layer is formed on a surface of the ribbon body. The forming process of the dye layer in embodiment 5 is same as the step 1.5 described in embodiment 1.

### Embodiment 6

6.1 The SiO₂/PET masterbatch provided from embodiment 2 and the Tal PET masterbatch provided from embodiment 4 are mixed together, wherein the mass ratio of both are 1:1. The mixed components are sequentially melted, cooled at 20° C. and cut by a twin-screw granulation machine, so that a SiO₂/Talc/PET masterbatch is provided. In addition, the temperature of the twin-screw granulation machine is in a range of 250-270° C.
6.2 The SiO₂/Talc/PET masterbatch is mixed with purified PET particles by mechanical agitation, so as to decrease the content of SiO₂ to 2.5 wt % and Talc to 2.5 wt %. Further, they are dried at 150° C. for 4 hrs. The dried particles are extruded by a single-screw extruder to form a flat film, wherein a condition of the single-screw extruder is described as following. A temperature of a screw of the extruder is in a range of 250-270° C. A temperature of an extrusion die of the extruder is in a range of 250-280° C. A temperature of a cooling roll of the extruder is in a range of 30° C. A rotational speed of the screw is in a range of 30-40 rpm. A rotational speed of a meter of the extruder is in a range of 10-15 rpm. A take-up speed of the extruder is in a range of 3-4 m/min. As a result, a thickness of the flat film is around 40 μm.
6.3 The flat film provided in step 62 is biaxial oriented by a biaxial oriented machine. The oriented temperature is 105° C. The oriented magnification is 3×3. The temperature of heat setting is 210° C. As a result, a ribbon body in embodiment 6 is provided, and a thickness of which is around 4.5
6.4 Further, a dye layer is formed on a surface of the ribbon body. The forming process of the dye layer in embodiment 6 is same as the step 1.5 described in embodiment 1.

### Embodiment 7

7.1 The CB/PET masterbatch provided from embodiment 3 and the Talc/PET masterbatch provided from embodiment 4 are mixed together, wherein the mass ratio of both are 1:1. The mixed components are sequentially melted, cooled at 20° C. and cut by a twin-screw granulation machine, so that a CB/Talc/PET masterbatch is provided. In addition, the temperature of the twin-screw granulation machine is in a range of 250-270° C.
7.2 The CB/Talc/PET masterbatch is mixed with purified PET particles by mechanical agitation, so as to decrease the content of Talc to 2.5 wt % and CB to 2.5 wt %. Further, they are dried at 150° C. for 4 hrs. The dried particles are extruded by a single-screw extruder to form a flat film, wherein a condition of the single-screw extruder is described as following. A temperature of a screw of the extruder is in a range of 250-270° C. A temperature of an extrusion die of the extruder is in a range of 250-280° C. A temperature of a cooling roll of the extruder is in a range of 30° C. A rotational speed of the screw is in a range of 30-40 rpm. A rotational speed of a meter of the extruder is in a range of 10-15 rpm. A take-up speed of the extruder is in a range of 3-4 m/min. As a result, a thickness of the flat film is around 40 μm.
7.3 The flat film provided in step 7.2 is biaxial oriented by a biaxial oriented machine. The oriented temperature is 105° C. The oriented magnification is 3×3. The temperature of heat setting is 210° C. As a result, a ribbon body in embodiment 7 is provided, and a thickness of which is around 4.5 μm.
7.4 Further, a dye layer is formed on a surface of the ribbon body. The forming process of the dye layer in embodiment 7 is same as the step 1.5 described in embodiment 1.

### Comparative Example 1

A PET film (available from Toray Lumirror) with 4.5-μm thickness is provided. A back-side layer is formed on a surface of the PET film, and then a dye layer is formed on another surface of the PET film. A forming process of the back-side layer is described as following. The back-side layer of 0.8 g/m² is coated on a surface of the PET film. In an embodiment of the present disclosure, a composition of the back-side layer includes 90.6 wt % of cellulose acetate propionate resin (CAP-482-0.5, available from Eastman Kodak), 0.4 wt % of polyisocyanate curing agent (Bayer Desmodur L75) and 0.54 wt % of fatty acid metal salt particles (SPZ-100F, available from Sakai Chemical Industry Co., Ltd). Further, the forming process of the dye layer in comparative example 1 is same as the step 1.5 described in embodiment 1.

### Comparative Example 2

A PET film (available from Toray Lumirror) with 4.5 μm thickness is provided. A dye layer is formed on a surface of the PET film. The forming process of the dye layer in comparative example 2 is same as the step 1.5 described in embodiment 1.

The color ribbons provided by embodiments 1-7 and comparative examples 1-2 is used for printing by Hiti P510S printer, in which the printing power is Cyan OD 1.0, and the paper is Hiti P510S paper. After printing, these color ribbons are appraised through comparison. The results are listed in Table 1.

TABLE 1

| | | with (W/) | |
|---|---|---|---|
| | | or without | condition |
| Color | | (W/O) back- | of ribbon |
| ribbons | composition of ribbon body | side layer | body |
| embodiment 1 | PET/SiO₂(0.3 wt %) | W/O | lightly |
| | | | wrinkled |
| embodiment 2 | PET/SiO₂(5 wt %) | W/O | smooth |
| embodiment 3 | PET/CB(5 wt %) | W/O | smooth |
| embodiment 4 | PET/Talc(5 wt %) | W/O | smooth |
| embodiment 5 | PET/SiO₂(2.5 wt %)/CB(2.5 | W/O | smooth |
| | wt %) | | |
| embodiment 6 | PET/SiO₂(2.5 wt %)/Talc(2.5 | W/O | smooth |
| | wt %) | | |
| embodiment 7 | PET/CB(2.5 wt %)/Talc(2.5 | W/O | smooth |
| | wt %) | | |
| comparative | PET | W/ | smooth |
| example 1 | | | |
| comparative | PET | W/O | wrinkled |
| example 2 | | | |

As the results listed in Table 1, if the ribbon body is merely formed of PET, and is without a back-side layer, the color ribbon may be wrinkled after printing. Therefore, the back-side layer must be formed while the ribbon body is merely formed of PET, such as the color ribbon provided by comparative examples 1, so as to address the issue of the wrinkled color ribbon. However, the color ribbons provided by embodiments 1-7 can address the issue of the wrinkled color ribbon without the additional back-side layer.

In another aspect, the dye ribbon for sublimation thermal transfer printing in accordance with various embodiments of the present disclosure includes the ribbon body having the lubricating and thermal resistant material dispersed in the substrate, such that the ribbon body has a lubricating and thermal resistant property. Due to the color ribbons provided by the present disclosure without an additional back-side layer, it can efficiently address the issue about an expiration date and unevenly coating of a coating material of a back-side layer in a conventional ribbon.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A dye ribbon for sublimation thermal transfer printing
a ribbon body, comprising:
a substrate; and
a lubricating and thermal resistant material dispersed in the substrate, the content of the lubricating and thermal resistant material being 0.5-20% of weight of the substrate; and
a dye layer disposed on the ribbon body.

2. The dye ribbon of claim 1, wherein the substrate is a flexible substrate.

3. The dye ribbon of claim 2, wherein a material of the flexible substrate is selected from the group consisting of polyethylene terephthalate (PET), polypropylene (PP), polyamide (PA), polyimide (PI), polystyrene (PS), polycarbonate (PC) and polyurethane (PU).

4. The dye ribbon of claim 1, wherein the lubricating and thermal resistant material is selected from the group consisting of talc, SiO2, CaCO3, aluminum nitride (AlN), SiC, Si3N4, boron nitride (BN), Al2O3, TiO2, CuO, carbon black, graphite, graphene, carbon nanotube and a combination thereof.

5. The dye ribbon of claim 1, wherein a particle size of the lubricating and thermal resistant material is in a range of 10 nm to 3 μm.

6. The dye ribbon of claim 1, wherein the dye layer comprises one or more color blocks.

7. The dye ribbon of claim 6, wherein the dye layer further comprises a protection block.

8. The dye ribbon of claim 1, wherein the dye layer is directly in contact with a surface of the ribbon body.

9. The dye ribbon of claim 1, further comprising an adhesive layer disposed between the ribbon body and the dye layer.

10. The dye ribbon of claim 1, wherein a thickness of the ribbon body is in a range of 3-5.5 μm.
